(19) United States
(12) Patent Application Publication
(10) Pub. No.: US 2002/0031947 A1
(43) Pub. Date: Mar. 14, 2002

(54) Electrical connector module and electrical connector assembly including same

(76) Inventors: James Edward Gundermann, Warren, PA (US); Michael J. Bonavita, Warren, PA (US)

Correspondence Address: William H McNeil, Osram Sylvania Inc, 100 Endicott Street, Danvers, MA, 01923, US

(21) Appl. No.: 09/617,353

(22) Filed: Jul. 17, 2000

(51) Int. Cl. H01R 13/40

(52) U.S. Cl. 439/625

(57) ABSTRACT

An electrical connector module is provided which includes a housing having an internal tongue having a footprint useful in properly aligning an electrical contact, having a mating footprint, as such contact is being inserted therein. The tongue is useful in latching the contact in place within the housing. A tongue disabler is provided which prevents displacement of the tongue and therefore unlatching of the contact after the contact has been fully inserted in the housing. An electrical connector assembly which includes such module and such contact is also provided.

### TECHNICAL FIELD

The present invention relates to an electrical connector module useful in properly aligning one or more electrical contacts being inserted therein. An electrical connector assembly which includes such a module and contact(s) mounted therein is also provided. The present invention is particularly useful in those applications requiring increased contact density such as automotive applications.

### BACKGROUND ART

Electrical connector assemblies have many applications in industry. Many such connector assemblies typically include an electrically insulating housing into which one or more electrical contacts have been inserted. One problem in the fabrication of such connector assemblies is the difficulty in properly aligning the electrical contacts within the insulative housing. This is a particular problem in those applications when space is limited and miniaturization is therefore desirable. For example, contacts may be undesirably bent or the typical plastic-type insulative housing damaged when electrical contacts are improperly forced into the housing. Miniaturization is particularly desirable in the automotive industry, the current emphasis being on combining great reliability, miniaturization and reduced cost.

### DISCLOSURE OF THE INVENTION

It is an object of the present invention to provide an improved electrical connector module.

It is yet another object of the present invention to provide an electrical connector module which obviates the disadvantages of the prior art.

A further object of the present invention is to provide an electrical connector module which may be readily miniaturized.

Yet another object of the present invention is to provide an electrical connector module which includes an internal footprint useful in properly orienting a contact being inserted therein.

Another object of the present invention is to provide an electrical connector module useful in automotive applications.

A further object of the present invention is to provide an electrical connector assembly which provides one or more of the foregoing objects.

The present invention achieves these and other objects by providing an electrical connector module comprising an electrically insulating housing extending in a first direction of a first axis from a front end to a rear end. An electrical contact receiving aperture is provided in the housing and extends in the first direction. A tongue extends in the electrical contact receiving aperture. The tongue comprises a given cross-sectional one-way first footprint. The first footprint is structured and arranged to mate with a given cross-sectional one-way second footprint of an electrical contact adapted to be inserted into the aperture whereby only a single orientation of the contact in the aperture is permitted. An electrical connector assembly which includes such a module is also provided.

### BRIEF DESCRIPTION OF THE DRAWINGS

This invention may be clearly understood by reference to the attached drawings in which like reference numerals designate like parts and in which:

FIG. 1 is a perspective view of one embodiment of an electrical connector module of the present invention;

FIG. 2 is a perspective front view of the electrically insulative housing of the electrical connector module of FIG. 1;

FIG. 3 is a perspective rear view of the housing of FIG. 2;

FIG. 4 is a front end view of the housing of FIG. 2;

FIG. 5 is a rear end view of the housing of FIG. 2;

FIG. 6 is a cross-sectional view of FIG. 4 taken along lines 6-6 with a tongue disabler in a pre-assembly position and a contact partially inserted within the housing;

FIG. 7 is similar to FIG. 6 with the tongue disabler in a tongue disabling position and a contact fully inserted within the housing;

FIG. 8 is a cross-sectional view of FIG. 4, taken along lines 8-8;

FIG. 9 is a perspective view of a tongue of the housing of FIG. 2;

FIG. 10 is a perspective view of the electrical contact illustrated in FIGS. 6 and 7;

FIG. 11 is an end view of the electrical contact of FIG. 10;

FIG. 12 is perspective view of the front end of the tongue disabler illustrated in FIGS. 1, 6 and 7; and

FIG. 13 is a perspective view of the rear end of the tongue disabler of FIG. 12.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

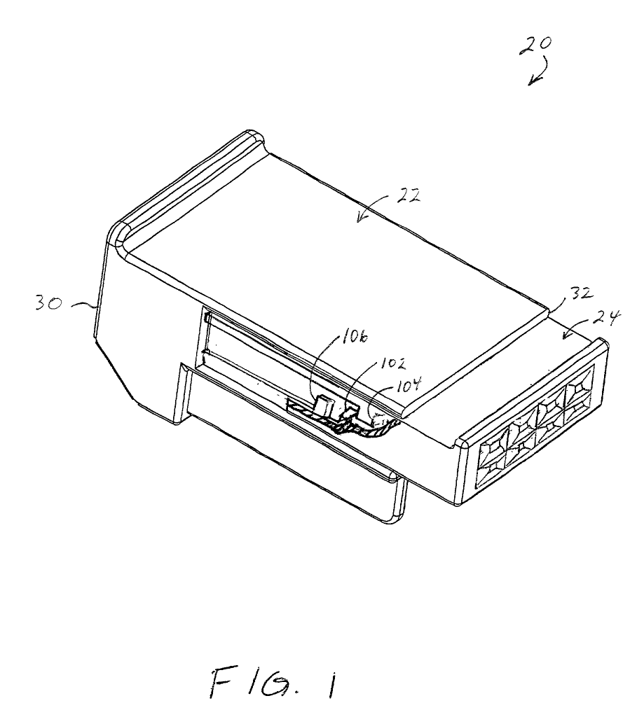

The embodiments of this invention which are illustrated in the drawings are particularly suited for achieving the objects of this invention. FIG. 1 illustrates an electrical connector module 20 which comprises an electrically insulative housing 22 and a tongue disabler 24. Housing 22 and tongue disabler 24 are slidably engagable with each other as explained herein.

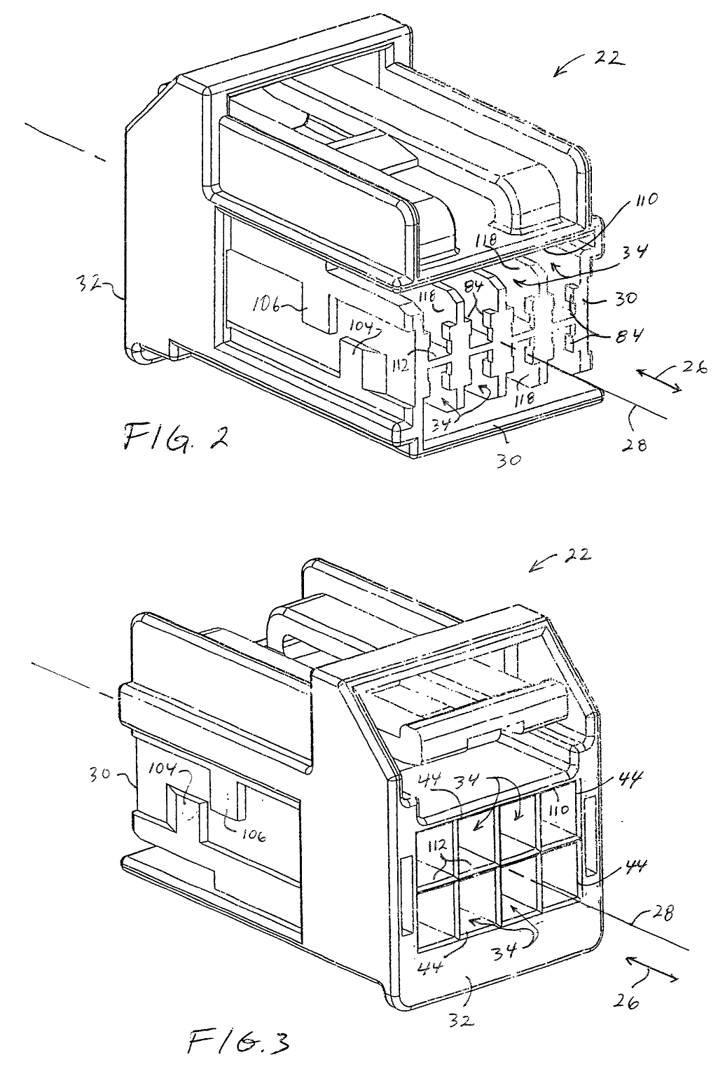

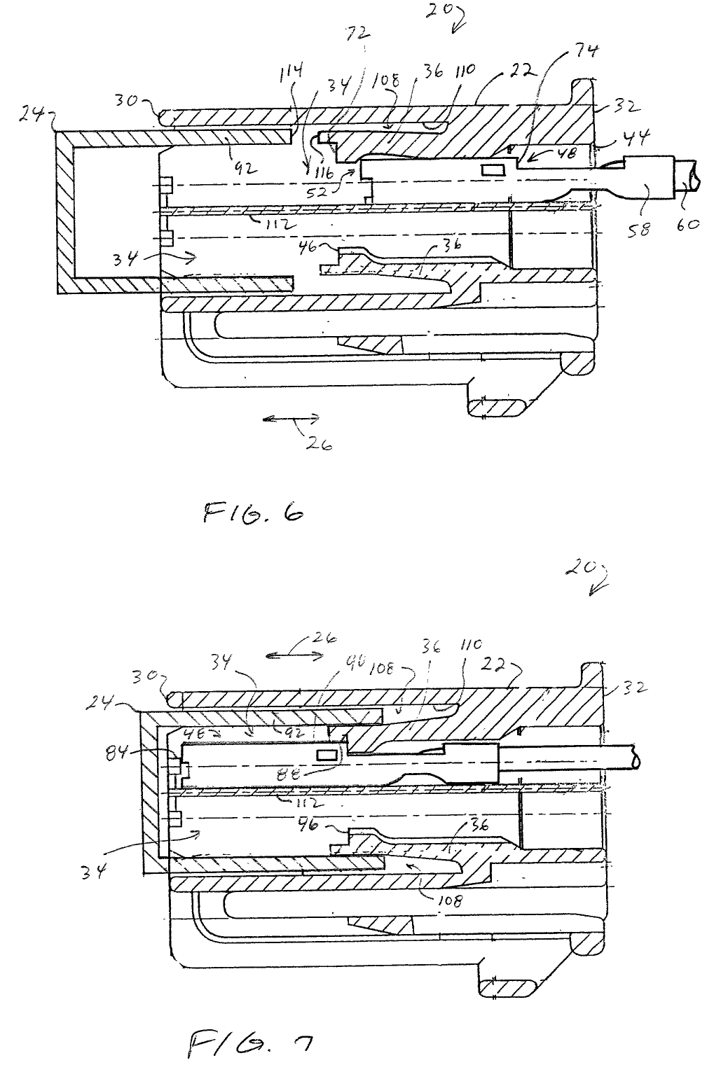

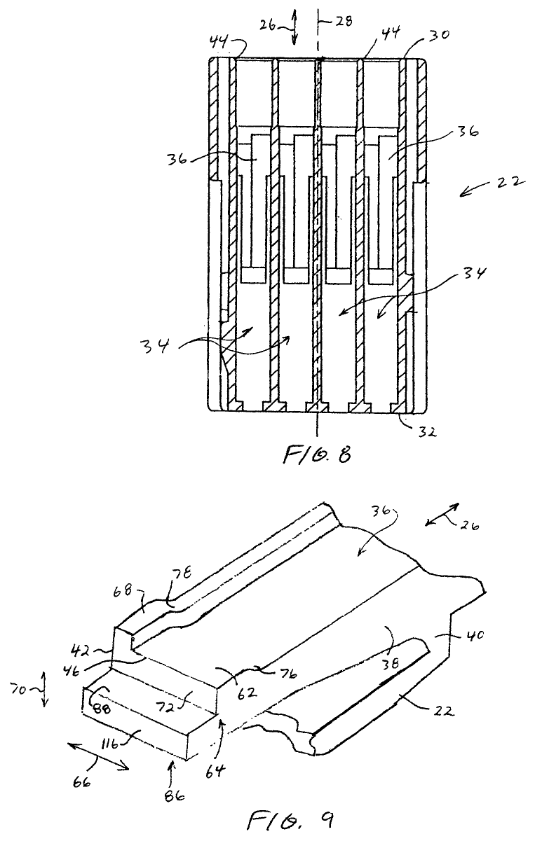

Referring to FIGS. 2 to 9, the electrically insulative housing 22 extends in direction 26 of a horizontal axis 28 from a front end 30 to a rear end 32. An electrical contact receiving aperture 34 is provided within housing 22. The aperture 34 extends in direction 26 from front end 30 to rear end 32. A tongue 36, best illustrated in FIGS. 6,7 and 9 extends in each electrical contact receiving aperture 34 in direction 26. In the embodiment illustrated in the drawings, tongue 36 is cantilevered from a proximate end 38 at housing wall 40 to a distal end 42. Without limitation, the electrically insulative housing 22 includes eight electrical contact receiving apertures 34 each of which has a tongue 36 extending therein. Each tongue 36 is structured and arranged to engage and properly orient a respective contact inserted into a respective aperture 34 through a respective opening 44 as described hereinafter.

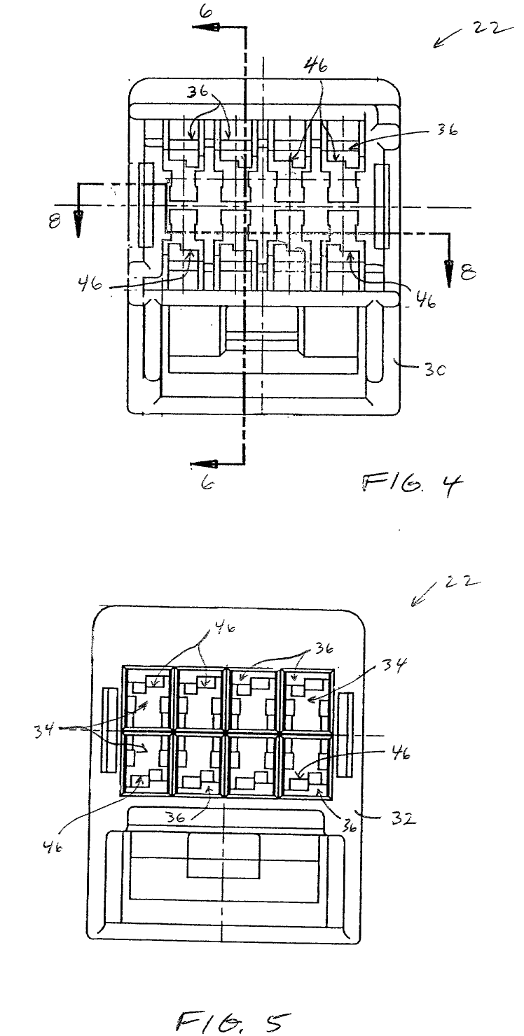

The tongue of the present invention comprises a given cross-sectional one-way footprint which is structured and arranged to mate with a given cross-sectional one-way footprint of an electrical contact adapted to be inserted into the electrical contact receiving aperture whereby only a single orientation of such contact in such aperture is permitted. For example, tongue 36 comprises a given cross-sectional footprint 46 which when viewed from the front end 30 is generally L-shaped as illustrated in FIG. 4. The configuration illustrated in FIG. 4 illustrates a preferred embodiment wherein at least some of the tongues 36 have a given cross-sectional one-way footprint oriented 180° from others of the tongues 36.

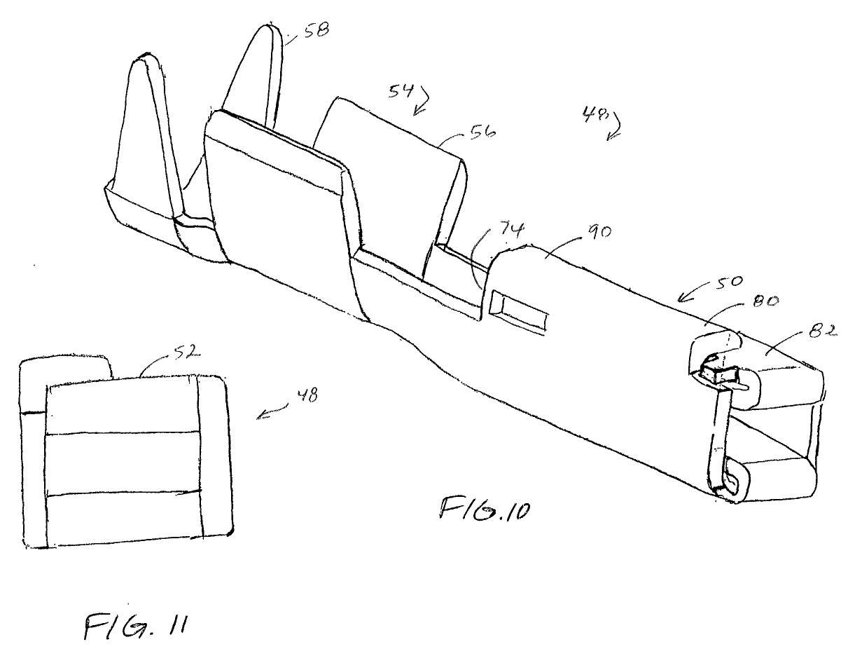

FIGS. 10 and 11 illustrate an electrical female contact 48 which is structured and arranged for positioning in the electrical contact receiving aperture 34. Without limitation, the contact 48 can be similar to one shown in U.S. Pat. No. 5,941,741 issued on Aug. 24, 1999 to Dobbelaere et al. In this instance, the electrical contact 48 is a female contact having a hollow, male receiving contact portion 50 which has the same generally L-shaped cross-sectional one-way footprint 52 as the footprint 46 of tongue 36 so that contact 48 can be inserted into the aperture 34 in housing 22 only one way. Positioned rearwardly from contact receiving portion 50 is a wire receiving portion 54 that has a cross-sectional area smaller than the cross-sectional area of the footprint 52. The portion 54 is provided with wings 56 for crimping a stripped wire and wings 58 for crimping about the wire insulation, thus firmly attaching an electrical wire 60 to the contact 48 as illustrated in FIGS. 6 and 7. In assembling the contacts 48 with the housing 22, each contact is inserted through a respective opening 44 and rotated about the longitudinal axis of the contact until the footprint 52 of the male receiving portion 50 of the contact 48 mates with the footprint 46 of the tongue 36. When the contact 48 is so oriented, it can be pushed all the way into the respective aperture 34 from rear end 32. It should be noted that although the footprints 46 and 52 are generally L-shaped, such footprints may comprise some other unique cross-section if desired. The important feature is that the footprints 46 and 52 share the same cross-section and that this cross-section permits only a single, desired orientation.

The tongue of the present invention may be displaceable and structured and arranged to retain the electrical contact within the electrical contact receiving aperture by engagement of the tongue with the contact when the contact is fully inserted into the aperture. For example, tongue 36 may be flexible thereby being displaceable in a direction transverse to the axis 28 as described hereinafter in more detail. With reference to FIG. 9, the L-shaped footprint 46 of the tongue 36 is bounded by a first tongue portion 62 extending in direction 26 from proximate end 38 to an end region 64. The first tongue portion 62 also extends in direction 66 which is transverse to direction 26. The L-shaped footprint 46 is also bounded by a second tongue portion 68 which extends in direction 26 from proximate end 38 to end region 64. The second tongue portion 68 also extends in direction 70 which is transverse to directions 26 and 66. The end region 64 comprises a latch surface 72 which is structured and arranged to latch with a surface 74 of the electrical contact 48 when the contact is fully inserted into the electrical contact receiving aperture 34. To this end, the tongue portions 62 and 68 each comprise a respective cam surface 76 and 78 which are each concave relative to axis 28. Cam surfaces 76 and 78 are positioned between the proximate end 38 of the tongue 36 and the end region 64. Cam surfaces 76 and 78 are structured and arranged to engage respective front end surfaces 80 and 82 of the contact 48 as the contact 48 is inserted into the aperture 34. During such insertion, the tongue 36 is cammed away from axis 28 as illustrated in FIG. 6. Further insertion of the contact 48 causes the front end of the contact to engage the stop 84 which extends from housing 22 into aperture 34, and the contact surface 74 to pass the tongue latch surface 72. At this point, the flexible tongue 36 will return to its original orientation, and the surface 74 will engage surface 72 to latch the contact 48 in place within the aperture 34 as illustrated in FIG. 7.

In the embodiment illustrated in the drawings, the tongue 36 may include a second end region 86 which extends from the first end region 64. End region 86 comprises an abutment surface 88 which is structured and arranged to engage a surface 90 of the electrical contact 48 when the contact is fully inserted into the aperture 34.

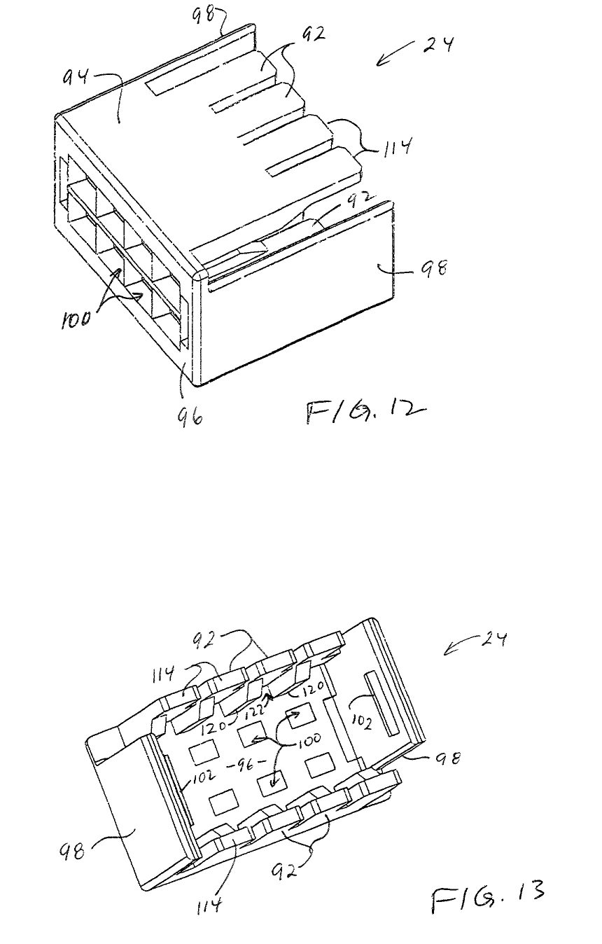

The electrical connector module of the present invention may include a tongue disabler useful in preventing movement of the tongue when the disabler is in an operative position thereby preventing unlatching of the electrical contact. For example, FIGS. 12 and 13 illustrate the tongue disabler 24. Tongue disabler 24 comprises a plurality of opposite arms 92 which extend from respective opposite bridging surfaces 94 which extend from a base 96. Each side of the disabler 24 includes a flexible wall 98 which extends from the base 96. Base 96 includes apertures 100 each of which aligns with a respective electrical contact receiving aperture 34 when the disabler 24 is coupled to the housing 22. To this end, the tongue disabler 24 is displaceably coupled to the front end 30 of the housing 22 at a first position illustrated in FIGS. 1 and 6, the tongue disabler being latched to the housing 22 by latching of the protuberances 102 extending from walls 98 with respective protuberances 104 extending from the housing 22 as the disabler is pushed into position from the front end 30 of housing 22. As illustrated in FIG. 6, when in such first position, the arms 92 extend into respective apertures 34 but do not lockingly engage the tongues 36. As illustrated in FIGS. 7, when the contacts 48 have been fully inserted into respective apertures 34, the disabler arms 92 may be pushed further into the apertures 34 of the housing 22 from front end 30 to a second position. To this end, the disabler walls 98 are caused to further slideably engage the housing 22 until the protuberances 102 latch with respective protuberances 106 extending from the housing. When in such second position, the disabler aims 92 will engage the tongues 36 to prevent any displacement thereof sufficient to unlatch the contacts 48 from the tongues. In particular, as the disabler 24 is being pushed to the second position illustrated in FIG. 7, each arm 92 will extend into a respective recess 108 between tongue 36 and a respective inner housing wall 110. In the embodiment illustrated in FIG. 7, the contact 48 will be locked in place between wall 110 and a wall 112 of housing 22. It should be noted that it will not be possible to push the disabler 24 into housing 22 from the first position illustrated in FIG. 6 to the second position illustrated in FIG. 7 if the contacts 48 have not been fully inserted into respective apertures 34. In particular, when a contact 48 has only been partially inserted into an aperture 34, the pushing of the tongue disabler 24 towards the second position will cause the edge 114 of each disabler arm 92 to abut the edge 116 of a respective tongue 36 to which an incompletely inserted contact is to be latched, as is apparent in FIG. 6.

Insertion of the arms 92 of the disabler 24 into respective apertures 34 may be facilitated by providing the housing with one or more alignment walls and the tongue disabler with one or more slots which mate with such walls. For example, in the embodiment illustrated in the drawings, the housing 22 includes a plurality of alignment walls 118 which extend in the direction 26 of axis 28. Tongue disabler 24 comprises a plurality of ribs 120 which provide respective slots 122 therebetween. Each slot 122 is structured and arranged to mate with a respective alignment wall 118 to properly align the disabler 24 with the housing 22 to thereby facilitate relative displacement thereof.

Fabrication of the components of the present invention may be accomplished using conventional procedures. For example, the electrically insulating housing, including the tongue, and the tongue disabler may be molded from plastic material, and the electrical contact may be stamped or otherwise cut from metal and folded or otherwise bent as required.

The embodiments which have been described herein are but some of several which utilize this invention and are set forth here by way of illustration but not of limitation. It is apparent that many other embodiments which will be readily apparent to those skilled in the art may be made without departing materially from the spirit and scope of this invention.

Claims:

1. An electrical connector module comprising:
an electrically insulating housing extending in a first direction of a first axis;
an electrical contact receiving aperture in said housing extending in said first direction; and
a tongue extending in said electrical contact receiving aperture, said tongue comprising a given cross-sectional one-way first footprint, said first footprint being structured and arranged to mate with a given cross-sectional one-way second footprint of an electrical contact adapted to be inserted into said aperture whereby only a single orientation of said contact in said aperture is permitted.

2. The electrical connector module of claim 1 comprising a plurality of said tongues, at least some of said tongues having said given cross-sectional one-way first footprint oriented 180° from others of said tongues.

3. The electrical connector module of claim 1 wherein said tongue is displaceable, said tongue being structured and arranged to retain said electrical contact within said electrical contact receiving aperture, by engagement of said tongue with said electrical contact, when said electrical contact is fully inserted into said electrical contact receiving aperture.

4. The electrical connector module of claim 3 further including a tongue disabler displaceably coupled to said housing, said tongue disabler being structured and arranged to be displaced relative to said housing from a non-locking first position relative to said tongue when said electrical contact has not been fully inserted into said electrical contact receiving aperture, to a locking second position relative to said tongue after said electrical contact has been fully inserted into said electrical contact receiving aperture.

5. The electrical connector module of claim 4 wherein said housing comprises at least one first latch and at least one second latch, and further wherein said tongue disabler comprises at least one third last, said latches being structured and arranged such that said third latch engages said first latch in said first position and engages said second latch in said second position.

6. The electrical connector module of claim 5 wherein said housing comprises at least one alignment wall extending in said first direction, and further wherein said tongue disabler comprises at least one slot which is structured and arranged to mate with said alignment wall to facilitate displacement of said tongue disabler relative to said housing.

7. The electrical connector module of claim 6 comprising a plurality of said tongues, at least some of said tongues having said given cross-sectional one-way first footprint oriented 1800 from others of said tongues.

8. The electrical connector module of claim 1 wherein said first footprint is bounded by a first tongue portion extending in said first direction from a proximate end at said housing to a first end region and extending in a second direction transverse to said first direction, and a second tongue portion extending in said first direction from said proximate end at said housing to said first end region and extending in a third direction transverse to said first and second directions, said first and second end regions comprising a latch surface structured and arranged to latch with a first surface of said electrical contact when said electrical contact is fully inserted into said electrical contact receiving aperture.

9. The electrical connector module of claim 8 wherein said tongue includes a second end region which extends from said first end region of said tongue, said second end region comprising an abutment surface structured and arranged to engage a second surface of said electrical contact when said electrical contact is fully inserted into said electrical contact receiving aperture.

10. The electrical connector module of claim 8 wherein said first tongue portion and said second tongue portion each comprise a respective cam surface which is concave relative to said first axis and is positioned between said proximate end and said first end region, each cam surface being structured and arranged to engage said contact and be urged away from said axis as said contact is being inserted into said electrical contact receiving aperture.

11. The electrical connector module of claim 10 wherein said tongue is displaceable, said tongue being structured and arranged to retain said electrical contact within said electrical contact receiving aperture, by engagement of said tongue with said electrical contact, when said electrical contact is fully inserted into said electrical contact receiving aperture.

12. The electrical connector module of claim 11 further including a tongue disabler displaceably coupled to said housing, said tongue disabler being structured and arranged to be displaced relative to said housing from a non-locking first position relative to said tongue when said electrical contact has not been fully inserted into said electrical contact receiving aperture, to a locking second position relative to said tongue after said electrical contact has been fully inserted into said electrical contact receiving aperture.

13. The electrical connector module of claim 12 wherein said housing comprises at least one first latch and at least one second latch, and further wherein said tongue disabler comprises at least one third last, said latches being structured and arranged such that said third latch engages said first latch in said first position and engages said second latch in said second position.

14. The electrical connector module of claim 13 wherein said housing comprises at least one alignment wall extending in said first direction, and further wherein said tongue disabler comprises at least one slot which is structured and arranged to mate with said alignment wall to facilitate displacement of said tongue disabler relative to said housing.

15. The electrical connector module of claim 14 comprising a plurality of said tongues, at least some of said tongues having said given cross-sectional one-way first footprint oriented 180° from others of said tongues.

16. An electrical connector assembly, comprising:
an electrically insulating housing extending in a first direction of a first axis;
an electrical contact receiving aperture in said housing extending in said first direction;
a tongue extending in said electrical contact receiving aperture, said tongue comprising a given cross-sectional one-way first footprint; and
an electrical contact positioned in said electrical contact receiving aperture and comprising a given cross-sectional one-way second footprint structured and arranged to mate with said first footprint during insertion of said contact into said electrical contact receiving aperture whereby only a single orientation of said contact in said aperture is permitted.

17. The electrical connector assembly of claim 16 comprising a plurality of said tongues, each extending into a respective of said apertures, at least some of said tongues having said cross-sectional one-way first footprint oriented 180° from others of said tongues, and a plurality of said electrical contacts, each of which extends into a respective of said apertures.

18. The electrical connector assembly of claim 16 wherein said tongue is displaceable, said tongue engaging said electrical contact thereby latching said electrical contact in place within said electrical contact receiving aperture when said electrical contact is fully inserted into said electrical contact receiving aperture.

19. The electrical connector assembly of claim 18 further including a tongue disabler displaceably coupled to said housing, said tongue disabler being structured and arranged to be displaced relative to said housing from a non-locking first position relative to said tongue when said electrical contact has not been fully inserted into said electrical contact receiving aperture, to a locking second position relative to said tongue at which said tongue disabler engages said tongue to lock said contact in place within said aperture after said electrical contact has been fully inserted into said electrical contact receiving aperture.

20. The electrical connector module of claim 19 wherein said housing comprises at least one first latch and at least one second latch, and further wherein said tongue disabler comprises at least one third last, said latches being structured and arranged such that said third latch engages said first latch in said first position and engages said second latch in said second position.
